(19) United States
(12) Patent Application Publication
(10) Pub. No.: US 2003/0049592 A1
(43) Pub. Date: Mar. 13, 2003

(54) Database of learning materials and method for providing learning materials to a learner using computer system

(76) Inventor: Nam-Kyo Park, Kyungki-do (KR)

Correspondence Address: Blakely Sokoloff Taylor & Zafman, 7th Floor, 12400 Wilshire Boulevard, Los Angeles, CA, 90025-1026, US

(21) Appl. No.: 10/239,803

(22) PCT Filed: Mar. 24, 2001
(86) PCT No.: PCT/KR01/00481

(30) Foreign Application Priority Data
Mar. 24, 2000 (KR) 2000-15171

(51) Int. Cl. G09B 7/00

(52) U.S. Cl. 434/322

(57) ABSTRACT

The present invention relates to a database of a learning materials and a method for providing the learning materials to a learner. The database according to the present invention comprises: a first data structure storing a plurality of learning questions, which have at least one segment phrase and key word, wherein the segment phrase has at least one word then provides a meaning to a learner; a second data structure storing a plurality of detailed materials corresponding to the segment phrase and key word; and a table storing correlation information between the first and second data structures. The database according to the present invention has the learner learning the learning materials using a computer system based on his interest and education level.

### FIELD OF THE INVENTION

The present invention relates to a learning method using a computer program; and, more particularly, to a computer recordable media for reading a program which containing the method.

### DESCRIPTION OF THE PRIOR ART

When teaching students with the same contents and methods based on medium level students, teachers may have difficulties in teaching because high-level students may feel the class too easy and lose their interests, and low-level students may also lose their interests to the class on a converse reason.

However, among the service fields provided by Internet, the most developing field is an electronic commerce that is related to daily life, and especially, an educational system using Internet.

A remote education based on Internet overcomes limitations of educational spaces. That is, recently, the Internet is populated and a request for diversification, specification and an easiness in a learning method is planned as a demand for substituting uniform, passive and undemocratic learning methods, and a learning method using internet is on the rise to improve current educational environment, such as a ratio of teacher to student.

Moreover, the learning method using the Internet may be more growing through increased basic infra of Internet, e.g., PC room, a rapid spread of super-high speed communication network, an increased document expression technology development, e.g., a hypertext markup language (HTML) and an extensible markup language (XML) and swelling of a private educational market according to an overall permission.

Nevertheless, the Internet educational services are still in a basic level and the research thereof is slow due to various standardization problems. Also, the on-line education merely has transmitted conventional textbooks or reference books on the Internet.

As above described, conventional learning method through textbook and merely transmitting contents of textbooks could not increase an educational efficiency. Moreover, an education via the Internet is still in a basic step.

Generally, in a problems by using textbooks, if a learner has not have a tutor, the learner hardly checks his or her problems, thereby continuously making the same mistakes. Therefore, an alternative plan thereof is seriously needed.

When memorizing a foreign vocabulary, an idiom, a construction, various formula and an important material, learners usually memorizes them recklessly, so the learner stops to memorize them easily, and when a learner solves problems, if they just solve the problems, it can easily made the learner tired. In the above cases, if the learners solve the problems in such a manner that they play a game, an educational efficiency of the learner may be more increased.

### SUMMARY OF THE INVENTION

It is, therefore, an object of the present invention is to provide a learning method using a computer program and a computer readable media for reading a program which containing the method to increase learning ability of a learner.

Another object of the present invention is to provide a memorizing method for memorizing a vocabulary, an idiom and formula, etc., without boring, and is to solve various learning problems in such a manner that they play a game, thereby increasing learning ability of a learner.

In accordance with an aspect of the present invention, there is provided an educational material database structure to provide effective learning materials, comprising: a first material structure storing a plurality of learning problems, which have at least one segment phrase and key word, wherein the segment phrase has at least one word and then provides a meaning associated with the problem to a learner; a second material structure storing a plurality of detailed materials corresponding to the segment phrase and key word; and a first table storing correlation information between the first and second material structures.

Also, the present invention further comprises a second table for denoting the segment phrase or the key word, which have more important contents in solving the problem.

Also, the present invention further comprises a third material structure for storing considerable contents when a learner selects a correct answer among examples presented in an objective selective problem.

Also, the present invention further comprises a fourth material structure for storing correct analyzing process in selecting correct answer according to considerable contents in problem solving.

Also, the present invention further comprises a fifth material structure for explaining correlation between each examples and contents of the problems.

Also, the present invention further comprises a sixth material structure for storing contents, which the learner may additionally learn in accordance with the contents of the problems.

Also, the present invention further comprises a seventh structure for converting the segment phrase or key word, which are represented in a language to a numerical expression or schematize symbols.

Also, the present invention further comprises an eighth structure for storing statistical material, which analyzes achievement rate of a learner based on a result or the problem solving.

Also, the present invention further comprises a ninth structure for showing correlation between examples and the provided problems.

In accordance with another aspect of the present invention, there is provided a method for providing learning material to a learner who is connected to a computer system through a network, comprising the steps of: a) structuring learning material into a database, wherein the learning material may lead to a way of problem solving; b) providing a corresponded problem to a learner in accordance with a selection or an input of the learner; c) according to the selection or the input of the learner, showing a corresponding learning material, interpreting a right or a false of the problem solving process by using a problem analyzing material and noticing a result; and d) presenting a correct problem solving way to check a reason for a false answer to the problem which the learner want to solve.

In accordance with further another aspect of the present invention, there is provided A database managing system having a processor for providing effective learning materials, which are recordable in a computer, comprising: a first material structure for storing a plurality of learning problems, which have at least one segment phrase and a key word, wherein the segment phrase has at least one word, and provides a meaning associated with the problem to a learner; a second material structure for storing a plurality of detailed materials corresponding to the segment phrase and the key word; a table for storing correlation information between the first and second material structures; a second table for denoting the segment phrases or the key words, which have more important contents in solving the problem; a third material structure for storing considerable contents when a learner selects a correct answer among examples presented in an objective selective problem; a fourth material structure for storing correct analyzing process in selecting the correct answer according to a considerable contents in problem solving; a fifth material structure for explaining correlation between each examples and contents of the problems; a sixth material structure for storing contents, which the learner may additionally learn in accordance with the contents of the problems; a seventh structure for converting the segment phrase or the key word, which are represented in a language to a numerical expression or a schematize symbol; an eighth structure for storing statistical material, which analyzes an achievement rate of the learner based on a result or the problem solving; and a ninth structure for showing correlation between examples and provided problems.

In accordance with still further another aspect of the present invention, there is provided A database managing system having a processor for providing effective learning materials, which are recordable in a computer, comprising the functions of: a) structuring learning material into a database, wherein the learning material may lead to a way of problem solving; b) providing a corresponded problem to a learner in accordance with a selection or an input of the learner; c) according to the selection or the input of the learner, showing a corresponding learning material, interpreting a right or a false of the problem solving process by using a problem analyzing material and noticing a result; and d) presenting a correct problem solving way to check a reason for a false answer to the problem which the learner want to solve.

The present invention is related to an educational program using a computer for increasing a problem solving ability and a learner may statistically correct his or her mistakes in a problem solving by accumulating learner's problem solving process into a material. Therefore, the present invention may give learner self-confidence in learning.

Also, when a learner memorizes a vocabulary, an idiom, an important construction and formula, etc., the present invention provides various learning problems in a gaming way, so that the learner may not feel boring.

### BRIEF DESCRIPTION OF THE DRAWINGS

Other objects and aspects of the invention will become apparent from the following description of the embodiments with reference to the accompanying drawings, in which:

FIG. 1 is a schematic diagram illustrating an educational system in accordance with the present invention;

FIG. 2 is a diagram showing a division process of a problem in structuring database or description type materials on an intellect basis;

FIG. 3A is a diagram showing an relationship between a correct answer and a similar answer (not correct answer) in accordance with an embodiment of the present invention;

FIG. 3B is a diagram showing an education achievement analyzing process in accordance with an embodiment of the present invention;

FIG. 3C is a diagram showing an educational achievement analyzing process in accordance with another embodiment of the present invention;

FIG. 4 is a whole flow chart showing a learning material providing process in accordance with a first embodiment of the present invention;

FIG. 5 is a detailed flow chart showing an intellectual problem solving process of FIG. 4 in accordance with an embodiment of the present invention;

FIG. 6 is a detailed flow chart showing a practical problem solving process of FIG. 4 in accordance with an embodiment of the present invention;

FIG. 7 is a flow chart showing an educational material providing method in accordance with a second embodiment of the present invention;

FIG. 8 is a flow chart showing a learning material providing method in accordance with a third embodiment of the present invention;

FIG. 9 is a flow chart showing a learning material providing method in accordance with a fourth embodiment of the present invention; and

FIG. 10 is a flow chart showing a learning material providing method in accordance with a fifth embodiment of the present invention.

### DETAILED DESCRIPTION OF THE PREFERRED EMBODIMENTS

Hereinafter, a learning method using a computer program according to the present invention will be described in detail referring to the accompanying drawings.

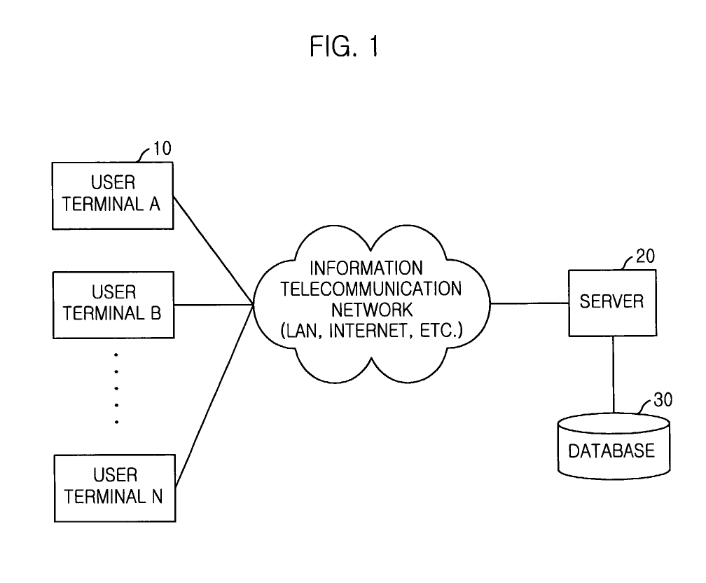

FIG. 1 is a schematic diagram illustrating an educational system in accordance with the present invention.

Referring to FIG. 1, a learning system in accordance with the present invention includes a plurality of user terminals 10 for uniting a user (a learner or a student) and a lecturer (a teacher), a problem solving program (a practical problem solving and an intellectual problem solving, etc.) stored in a database 30 for increasing a learner's intellectual capacity and learning ability, wherein the database 30 stores programs suit for a learner's ability, a game-type learning program for effectively memorizing a vocabulary, an idiom, an important content and formula, etc., without boring, and a server 20 which provides communication between learners and learners, and teachers and teachers.

Each of users is classified into a lecturer (or a teacher) and a learner (or a student) and an set-up window is generated on the lecturer's terminal, wherein the set-up window can establish a lecture process, then each of the learner (or a student) can access permitted material from the lecturer's monitor through a log-in process. It is for a local area network (LAN) using education in a limited space, such as an academy.

Besides, each of learner (student) may use a problem solving program and a game-type program in an outside of the academy, such as home and PC room, etc., by directly connecting to the server 20 through the Internet.

An information communication network, such as the Internet and LAN, is established by connecting a communication network between the plurality of users terminal 10 and the server 20 to make a material communication related to educational information.

Consequently, the plurality of user terminals 10, are personal PCs, which equip a communication device (e.g., modem, etc.), a monitor, a keyboard (or a keypad), a mouse, a voice sensible device, or notebooks. Also, a mobile communication terminal, such as a personal digital assistants (PDA), cellular phone and PCS phone, etc., and a next generation mobile communication device, such as an international mobile telecommunication IMT-2000 and a universal mobile telecommunications service (UMTS) can be used as a user device.

The database 30 stores a problem solving program and a game-type program, and a learning result of the problem solving program and the game-type program, that is a learning level evaluation and an analyzing material, are stored. Also the database 30 stores advertisements and multimedia contents provided by an owner of the advertisement or a corporation, and then they may be showed on users' displays, especially when the game-type program is provided. At this time, the learning level evaluation and the analyzing material, which are stored as a learning result, may be a learning pattern, learning level, achievement and exercising test results. Of course, when a database 30 is constructed, a learner (or a student) can be classified and recorded for each the lecturer after classifying lecturers (or teachers).

The server 20 provides a problem solving services, between the students and the teacher, a game-type service, a teacher communication service, a student communication service, a practical examination and an educational information providing service on the basis of the database 30.

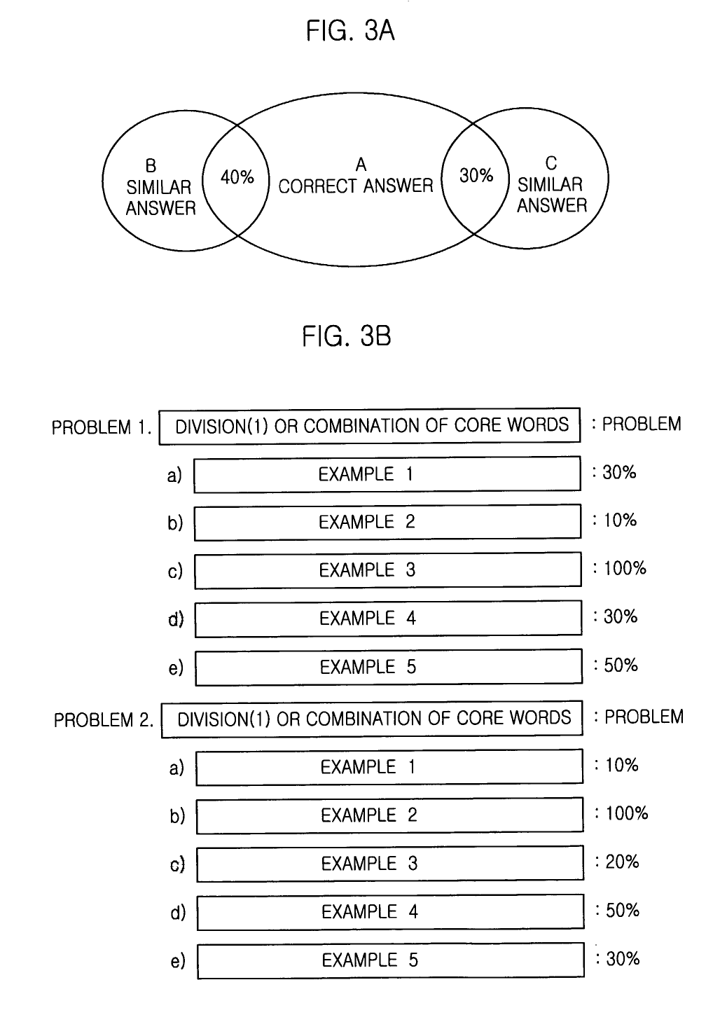

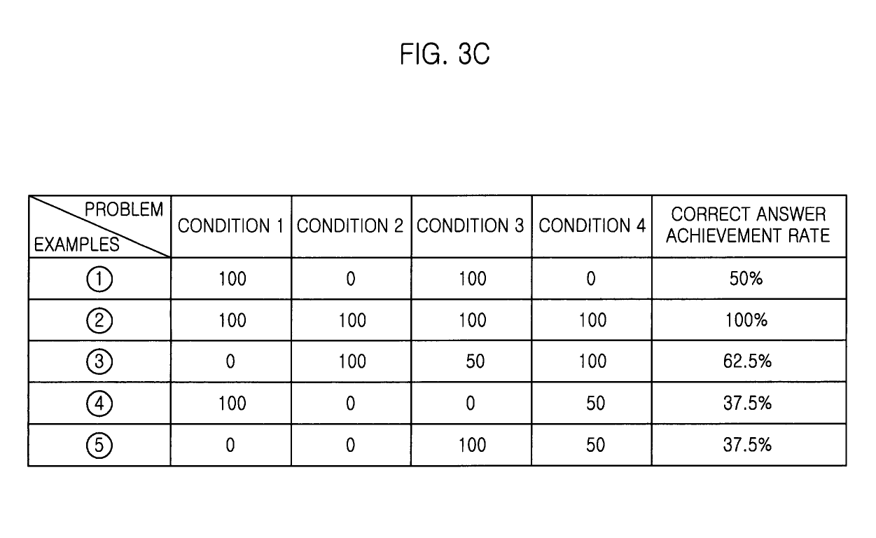

Of course, the problem solving program for solving the problems and the game-type program services are may be constructed to be selected by a learner (or a student) in each step. However, a lecturer (or a teacher) can select content and provide it to the learner and at this time, the server 20 provides a learning pattern, a learning level and an achievement of the learner to the lecturer on the basis of technical analysis (referring to FIG. 3B). Also, the lecturer provides corresponding contents within the problem solving service and the game-type service so that a fitting educational service between the lecturer and the learner is realized. Also, each of the learners can be provided man-to-man educational services through the Internet by connecting to the server 20 on the basis of the problem solving program and the game-type program. The problem solving program and the game-type program may be carried out by a cyber lecturer within the Internet. Also, each learner may contact to the server without helping of the lecturer to provide man-to-man educational service, which is on the basis of problem solving program and game-type program through an Internet communication. The problem solving program and game-type program can be performed by a cyber lecturer.

The server 20 may provide a man-to-man or one-to-many educational service on the basis of the problem solving program and the game-type program through Internet.

The man-to-man educational service is a fitting educational service capable of providing the problem solving program and the game-type program through the Internet. Learners (or students) may increase their intellectual development and an educational capability through the problem solving program and the game-type program. At this time, the lecturer may be a regular lecturer, a guest lecturer or may be a cyber lecturer on the Internet.

In the man-to-man service, a lecturer selects and provides contents fitted to the learners, and at this time, the server 20 analyzes the learning pattern, level and achievement of the learners and provides it to a lecturer so that the man-to-man education and learning through the Internet communication is possibly performed.

For the above, when a lecturer opens an Internet lecture, the problem solving program and the game-type program, which the lecturer want to lecture, on the server 20, the learners connect to the server 20 by using their terminals 10 and choose a lecture and the time when they want to learn.

Of course, as described above, the lecturer may be an actual lecturer internally and externally or a cyber lecturer on the Internet. At this time, when the lecturer is an external lecturer, the lecturer connects to the Internet by using his or her terminal and registers his or her career and characteristic of the lecture to the server 20, and may have an Internet lecture, the problem solving program and game-type program to the learners who want to take a lesson.

If the lecture hour is not matched between the lecturer and learners, a recorded lecture may be transmitted to the learner who takes the lecture through the Internet.

The man-to-man educational service is carried out without limit of time and space in a cyber space, and in the cyber space, the lecturer and the learners concludes an educational contract through the man-to-man educational system.

The lecturer selects corresponding contents (that is, an Internet lecture, a practical problem solving program and an intellectual problem solving program, etc.) fitted to the learners, a problem solving program and a game-type program, and when the learner submits paper selected by the lecture after solving the problem, a score and a statistical system analyzes weakness of the learner, and then notices it to the lecturer. At this time, the lecture guides the learner on the basis of the material taken from the score and the statistical system and inputs achieved degrees of the learner to an education management system.

The corresponding contents (that is, a practical problem solving program and an intellectual problem solving program, etc.) provided by the problem solving learning service and the game-type of learning service are converted and managed in a contents management and converting system. Besides the corresponding contents in the problem solving program and the game-type program, other contents provided from an external contents provider (i.e. enterprise) may be supplied to the database 30.

The lecturer's communication service provides communication between lecturers and provides a communication between lecturers who cares same learner group.

With the learner's communication service, the learners may exchange information through the learner's communication system. The learner who acquires membership may be included into the learner's communication without special limitation.

The practical examination services provides the practical examination to the learner according to a periodical program and it provides national ranking, correct answer rate per problems and a tendency of wrong answers.

The internal information of the community is maintained by a security system.

The educational information providing service provides an examination material information (information related to many test and an educational materials required to prepare to a test), and provides other information of an off-line educational institute.

Likewise, the server 20 may provide man-to-man educational service through a cyber lecturer. More specifically, first, the learner selects one course among the Internet lectures, the problem solving program and the game-type program, and takes a test to know his educational level then, the paper written by the learner is compared with a correct answer to evaluate his test grade and correct/wrong answer. An educational plan is established according to the learner's educational level and an education is carried out according to an educational plan. At this time, a periodic test is performed to evaluate and analyze the result and according to the material, the educational plan is amended to carry out an optimal education, which is fitted to the learner's level.

Through the fitting education (man-to-man education) service, a learner may learn in a convenient time and place without time restriction, select a lecturer suitable for the learner, take a systematic educational management, which are given an utmost educational effect with a low cost and, besides a simple education, an information exchange between learners are possible. Also, a vocabulary, an idiom, an important phrase, formula and memorizing contents of a memorizing course may be solved easily in such a manner that they play a game.

Meanwhile, besides the man-to-man educational service, hereinafter, one-to-many educational service will be described.

When a lecturer (a teacher) opens a lecture needed in an education through the server 20, the learners (students) connect to the Internet and take a lecture.

In here, a lecturer shown on a monitor and learners may directly see themselves in a small group by using a sound card, the contents of the lecture may be outputted with voice data to provide interactive lecture between the lecturer and the learners.

The lecturer may lecture in a broadcasting way which is one-way method to a plurality of learners and to the contents of the lecture, and the lecturer may take questions from the learners through a mail, a phone call, an E-mail and a Fax.

Hereinafter, a database construction method of the problem solving program and the game-type program, which are constructed to the database 30, will be specifically described.

First, each problem type (an affirmative type, a descriptive type, a simple type, a complex material type, a material providing type and a material analyze type, etc.) contained in Korean, English, Mathematics, An physics, Biology, Social studies, History, Good citizenship, Domestic science, Technical industry, Music, Art, Physical education and Special course, etc., are defined.

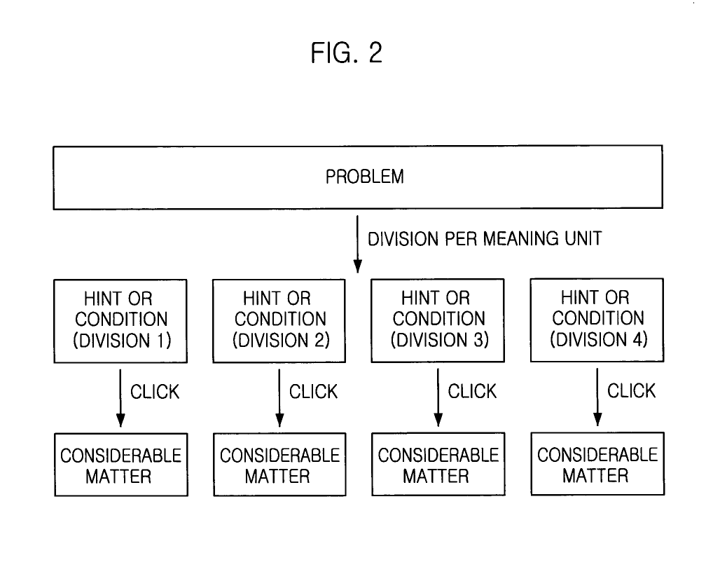

A problem provided from the database 30 in accordance with the present invention analyzes the corresponding problem, shown in FIG. 2, and comprises a plurality of segment phrase, which are divided according to on a meaning basis.

The divided meaning is defined as a key word (key material) and, according to a combination of problem and material including the divided meaning or the key word (key material), a concept definition, a hint or reference material, an attention and a pre-educational material are defined, then a specific problem solving way (method) are presented. For example, the divided meaning may be a linguistic (literal) expression of a segmented part of Mathematics, Science and Logic, etc., and the meaning of a word, an idiom, concept of a term, a synonym, an antonym and an etymology of a domestic language and a foreign language.

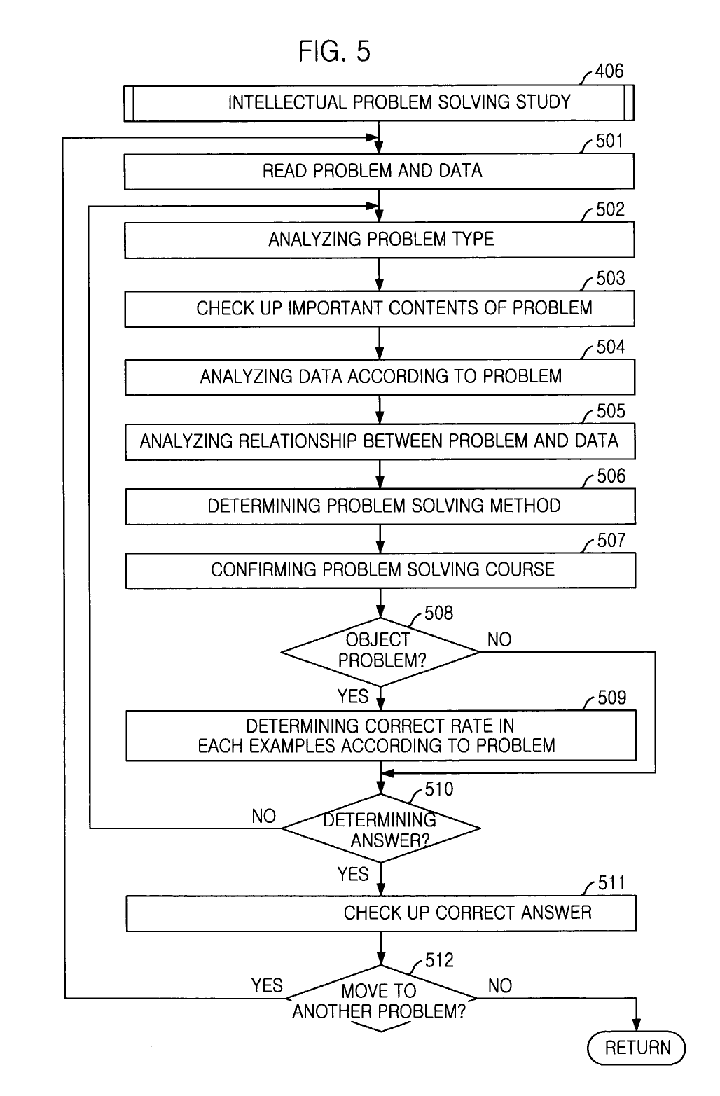

Also, as shown in FIG. 3A, the database 30 analyzes and evaluates the similarity of each wrong answers except a correct answer in an object problem so that it shows similarity of the examples (whole answers including a correct answer and wrong answers) into a numeral value, a chart, a graph, a picture and an expression of characters. That is, among the provided examples of the question, only one is a correct answer and the others are wrong answers. Therefore, the standard of discrimination clarifies that what thinking unit and key word the problem or material, e.g., articulated thinking unit (meaning unit), concept summaries on key words, hints, references, cautions, materials for prior study, etc., is related and adapted to. Calculating the total sum of how much the conditions for each thinking unit and key word are fulfilled, the similarity to the right answer is represented in figures, tables, graphs, pictures, facial expression of a character and so on. The similarity will be detailed described in FIG. 5.

Therefore, the database 30 comprises at least a first material structure storing a plurality of learning questions, which have at least one segment phrase and key word, wherein the segment phrase has at least one word and then provides a meaning to a learner, and a second material structure storing a plurality of detailed materials corresponding to the segment phrase and key word. A first table shows a segment phrase or a key word, which has the most important contents in solving the problem, and a second table for storing correlation between the first and the second material structure. Also, the database 30 comprises a third material structure for storing contents to be considered when a learner selects a correct answer among examples presented in an objective selective problem, a fourth material structure for storing correct analyzing process in selecting correct answer according to the considered contents in problem solving, a fifth material structure for explaining correlation between each examples and contents of the problems, a sixth material structure for storing contents, which the learner shall additionally learning in accordance with the contents of the problems, a seventh material structure for converting the segment phrase or key word, which are represented in a language to a numerical expression or a schematize symbol and an eighth material structure for storing statistical material, which analyzes achievement rate of a learner based on the result or the problem solving.

FIG. 3B is a diagram showing an education achievement analyzing process in accordance with an embodiment of the present invention and FIG. 3C is a diagram showing an education achievement analyzing process in accordance with another embodiment of the present invention.

If each example included in problem No.1 which are comprised with segment phrases or key words (key contents), the similarity of each wrong answers except a correct answer is analyzed and evaluated with the same way shown in FIG. 3A, and let's guess the result (achievement of correct answer) are a): 30%, b): 10%, c): 100%, d): 30%, e): 50%. Also, let's guess the result for similarity evaluation results (achievement of correct answer) for problem No. 2 are 1): 10%, b): 100%, c): 20%, d): 50%, e) 30%.

Actually, the correct answers of problem No. 1 and No. 2 are C) and b), respectively, but if a learner A selects the answer for problem No. 1 to d) and selects the answer for problem No. 2 to c), the learning achievement of the learner A is being 25%((30%+20%)/2=25%).

The learning achievement of the learner A for the problem No. 1 and 2 is accumulated into the database 30 and may be used as a statistical material of the learner A.

Consequently, based on the learning achievement, the database 30 may provide corresponding contents adapted to a learner's level.

If examples of the problem No. 1 and 2 are comprised with a long sentences, each example may be divided according to a key word or a key material and the achievement of a correct answer for each condition within each example of the problem No. 1 and 2 may be obtained as shown in FIG. 3C.

For example, when each condition of example 1 of wrong answer are compared with each condition of example 2, if each achievement are 100%, 0%, 100% and 0%, respectively, the achievement of the wrong answer of the example 1 would be 50%((100%+0%+100%+0%)/4).

In such a same way, when each condition of example 3 of wrong answer are compared with each condition of example 2, if each achievement are 0%, 100%, 50% and 100%, respectively, the achievement of the wrong answer of the example 3 would be 62.5%((0%+100%+50%+100%)/4.

Also, when each condition of example 4 and example 5 of wrong answer are compared with each condition of example 2, if each achievement example 4 of wrong answer are 100%, 0%, 0% and 50%, respectively, and if each achievement example 5 of wrong answer are 0%, 0%, 100% and 50%, respectively, the achievement of the wrong answer of the example 4 and 5 would be 37.5%((100%+0%+0%+50%)/4) and 37.5%((0%+0%+100%+50%)/4), respectively.

A learner may progressively approaches to the correct answer through several steps, i.e., a problem type understanding step (checking problem type), problem analyzing key word checking process of a problem (checking key contents), material analyzing key material checking process, problem & material combining logical analyzing process (correlation with problem and materials, analyzing material and references, etc.), solving method selecting process and specific solving examples analyzing process. More detailed explanation of the above-referenced matter will be explained in an intellectual problem solving learning process in FIG. 5.

For example, in physics, if the problem is provided as “A ball weighted 0.2 kg is thrown vertically in a speed of 20 m/s. Which would be wrong answer about the ball? (a resistance of an air is disregarded and a mass weight of 1 kg is 10 N), and let's guess examples are provided as below: 1) When thrown a ball, a kinetic energy of the ball is 40J. 2) A potential energy of the ball is 40J in an utmost point. 3) An utmost height of the ball is 20 m. 4) A potential energy and a kinetic energy may be the same in a point where a speed is being a half. 5) In any point, a dynamic energy is the same.

For reference, a type (a problem type (an affirmative type, a negative type)), a material type 1 (a simple type, a compounded material type), a material type 2 (a description type, a material providing type and a material analyzing type) of the physics are negative, simple and material providing types.

Also, the physics problem may be divided into “a)[a ball of 0.2 kg]/b)[vertically thrown with 20 m/s]/c)[which would be a wrong answer of the ball]/d)[(a resistance of an air is disregarded and a mass weight of 1 kg is 10 N.)]” and a key material of on the divided concept basis (on a meaning basis) is being c) which answers wrong movement of the ball.

Correlation analyzing process between the problems and the materials may be provided as follows: “by using conditions which provided by the materials, it is focused on the relations between a kinetic energy and a dynamic energy of a ball”.

Subsequently, in the problem analyzing process, “when a ball weighted 0.2 kg is vertically thrown in a speed of 20 m/s, a kinetic energy at the moment of the thrown is the same as a dynamic energy of the ball because a potential energy is 0. (dynamic energy=kinetic energy+potential energy)

Also, in a reference contents, “dynamic energy=kinetic energy+potential energy”, a law of mechanical energy conservation (when friction and resistance is not exist, all of potential energies are converted into a kinetic energy or all of kinetic energy are converted into a potential energy, to thereby always conserve dynamic energy which is sum of a potential energy and a kinetic energy regularly.) is provided.

Meanwhile, in the problem solving selection process, “a potential energy at the moment of thrown is the same as a dynamic energy of the ball, and the problem may be solved by considering that dynamic energy may be regularly maintained” is provided.

In the detailed solving process, “a dynamic energy of a ball=a potential energy when thrown a ball=½×0.2×202=40 J, and this is the same as the potential energy at the utmost point (mgh=40 J). Therefore, the utmost height of the ball is provided, “h=40×40×1/10×1/0.2=20 (m).”

Finally, in the examples analyzing process, it shows “1) When thrown a ball, a kinetic energy of the ball is 40J. ½ mv2=½×0.2×202=40 J. It's right, so wrong answer. 2) A potential energy of the ball is 40J in an utmost point. A dynamic energy is always regular due to there be no friction, and a kinetic energy at the moment of thrown is 40 J and it is same as the potential energy when it is at the utmost point. It's right, so wrong answer. 3) An utmost height of the ball is 20 m. A dynamic energy=a potential energy when a ball is thrown=40 J=a potential energy in an utmost point. 40=mgh=0.2×10×h, so h=20. It's right, so wrong answer. 4) A potential energy and a kinetic energy may be same in a point where a speed is being a half. When a speed is 20 m/s, a kinetic energy=40 J, a potential energy=0 J, so a dynamic energy of this object is 40 J. When the speed is a half, a kinetic energy=0.5×0.2×(10)2=10 J. A dynamic energy 40=a kinetic energy+a potential energy so, at this time, a potential energy is 30 J. Example is 10 J and right answer is 30 J, so it is correct answer. 5) In any points, a dynamic energy is same. The problem shows that it disregard a friction of an air, so a dynamic energy=a kinetic energy+a potential energy and the energy is always regular. It's right, so wrong answer.”

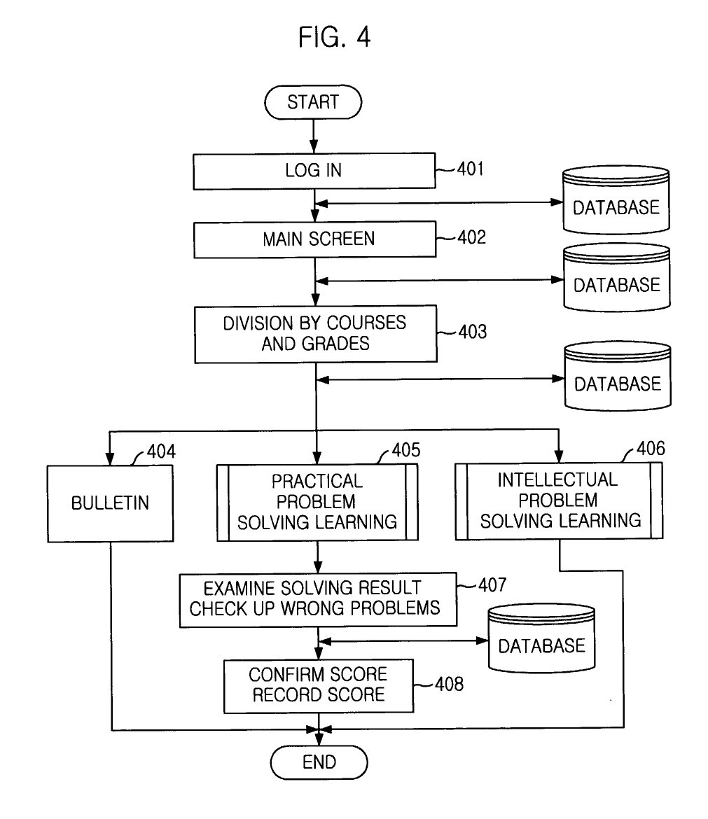

FIG. 4 is a whole flow chart showing a learning material providing process in accordance with a first embodiment of the present invention.

Referring to FIG. 4, in a learning material providing method in accordance with the present invention, a learner connects to the server 20 through the Internet and log-in, at step S401, the server 20 checks whether the learner is registered or not in the database 30, and if the learner is not registered, it leads the learner to a registration screen, otherwise, after checking a service usage period is valid, then moved to a main screen at step S402. The main screen includes a practical problem solving learning course, which is a type of examination at step S405, an intellectual problem solving learning (an individual fitting problem solving) course at step S406 and a question/answer bulletin S404.

At steps S405 and S406, in the problem solving course, which are provided through problem solving program, selections in each problem solving courses are accumulated individually, to statistically point out vividly wrong part and provide correction way thereof.

After that, when a learner solves a problem and submits an answer sheet, correct answers of the made problems are taken from the database 30 to check the answer and problem solving, at step S407, then a score is printed comparing with the submitted answer, at step S408. At this time, the printed score is transmitted to the database 30 again, and recorded in individual information of the learner, at step S408.

Hint and reference materials in the problem solving may be provided differently when the learner clicks an individual concept one or more than two, respectively.

Also, at steps S405 and S406, in the problem solving process, discrimination between a correct answer and a similar answer is denoted in a numeral value, graph or a picture, and shows that a standard of the discrimination is connected into which concepts, key words and key materials. Also, the hint and reference materials in the problem solving may be provided differently when the learner clicks an individual concept one or more than two, respectively.

The steps S405 and S406, the problem solving process may be provided in the middle of an Internet lecture, and it may be provided to a learner in the middle or after the corresponding lecture at an actual problem solving and an intellectual problem solving, respectively.

At this time, in the course of provide learning material to a learner, the learning materials and a voice of a lecturer are provided together. The course of providing the learning materials, an underline may be marked automatically in an important part of the learning materials in which an explanation and other material supply is needed. Also, an emphasis indication, coloring, shade treatment and a reverse images are displayed in a real time, and a moving picture, an animation and sound effects are provided with the lecture, thereby a learner may feel an actually hearing of the lecture from a lecturer or may feel more effects.

FIG. 5 is a detailed flow chart showing an intellectual problem solving process of FIG. 4 in accordance with an embodiment of the present invention.

When a learner selects problem, the server 20 transmits problem code of the selected problem to the database 30, and the database 30 takes step code corresponding to an explain step of a problem with the problem code, and makes them into one intellectual problem to show it to the learner.

One problem has a plurality of explanation steps corresponding to the problem. Each explanation step of the problem provides analyzed materials, reference contents and pictures corresponding to the problem to the learner. That is, not only an overall explanation is provided to a learner, but also a problem is provided to a learner by dividing it into analysis and solving concepts so that the learner systematically analyzes and understands the problem.

Each explanation step has a different structure and sequence according to the characteristic of the corresponding problems. At step S502, the learner analyzes the problem type, at step S503, the learner analyzes the problem by checking important contents of the problem and the key words on a meaning basis. At step S504, the learner analyzes materials, such as reference materials, pictures and additional explanations. At step S505, the learner analyzes problem and correlation in accordance with the materials. At step S506, the learner determines a problem solving method on the basis of the provided analyzed materials and at step S507, checks the problem solving process. At step S508, the learner determines the problem is an object one or a subjective one. At step S509, in case of the objective problem, the learner checks explanation of a correct answer rate for each of the provided examples.

The above-described explanation steps are selectively and repeatedly provided in the problem solving course so that a learner may sufficiently refer to an explanation and analyzed materials.

At step S502, in the problem analyzing process, the problems are divided into an affirmative type, a negative type, a simple type and a compounded material type so that it provides characteristics, notices and analyzing method in each type at which the learner directly selects types of corresponding problems, and the problem analyzing process determines if the selection is right so that, whenever the learner solves problems, he or she may aware characteristics and notices of the problem.

At step S503, in the problem key word checking process, questions of a problem are divided on an independent concept basis (information or meaning basis), so one formula, condition and problem key is extracted in each concept and they are adapted into solving a problem. The key and information in a problem may be considered separately as shown in FIG. 2, and a learner may easily understand a problem by dividing a problem in a key or meaning. Additionally, for the learner who lack in problem analyzing ability or needed more information, when a learner clicks a divided condition (cause or phrase) or a key contents with a mouse as shown in FIG. 2, analyzed materials related to thereof are provided to help him in understanding the problem.

For example, in case of mathematics and science, each concept (on a conditional basis and on a clue basis) described in a language is converted into a numeral formula, etc., thereby to increase application of learners. Also, each problem has the most important key words, dividing the key words in a segment phrases. Therefore, when the learners understand key words, they may grasp intention of the problem more easily and quickly. The key words may be included more than two in a problem, and each of the key words has a hint like a segment phrase so that the learner may refer to the hint by clicking a mouse.

At step S503, in the problem key word checking process, the learners select the most important segment phrases with a key word to increase analyzing capability of whole problem by training concept ability in each meaning of a problem and a key word determining ability.

At step S504, in the problem material analyzing process, reference materials and pictures provided in a problem are analyzed and explained. The problem material analyzing process selectively explains information contained in the problem to learners and, at step S505, in the analyzing process between a problem and materials according to the problem, the correlation between a problem and corresponding materials is analyzed thereby to increase analyzing capability of the problem materials.

At step S506 of determining a solving solution, the solving method is determined after finding out clues for problem solution based on the description and materials analyzed before. Then, at step S507, the solving procedures are presented in detail so that learners can have the correct way in solving the problems.

At step S508, in case of an objective problem, each example answers are explained. How close each answer is to the correct answer is shown in percentage and presented in graphics so that the learner can figure out the correct answer. For instance, if an example is the right answer, it will be 100%. If it is not the correct answer but related somewhat to it, it will be represented in 20%. Learners frequently run into an objective question with possible right answers of two or three. Here, they commonly make an error in judgment and get a wrong answer. Wrong answers are obtained when the discrimination between the right answer and another answer similar to it is relatively weak. The discrimination is felt weak when the correct answer and one similar to it has something in common as shown in FIG. 3A. For example, as shown in FIG. 3A, the part A of the ban diagram is the right answer while the part B has 40% of similarity and the part C, 30% of similarity. In this case, the part A comes to the right answer that fulfills the condition for the right answer 100%. Then, it gets to be in question what is the ground that makes answers 100%, 40% and 30% right. This depends on how the answer fits to the clues and conditions given in the question or materials. That is, it depends upon how the leaner analyzed the intention of the question accurately.

At each step of explanation, difficult words or background knowledge are presented to learners for reference.

Finally, at step S510, when the learner decides on the answer. At step S511, it is determined if it is right or wrong and, at step S512, the next question is presented continuously according to the choice of the learner.

Analysis materials of all description steps are presented as per the learner's choice. By describing the procedures of solving a problem step by step, the learner can strengthen his ability of problem analysis and improve the learning ability by reinforcing weak points.

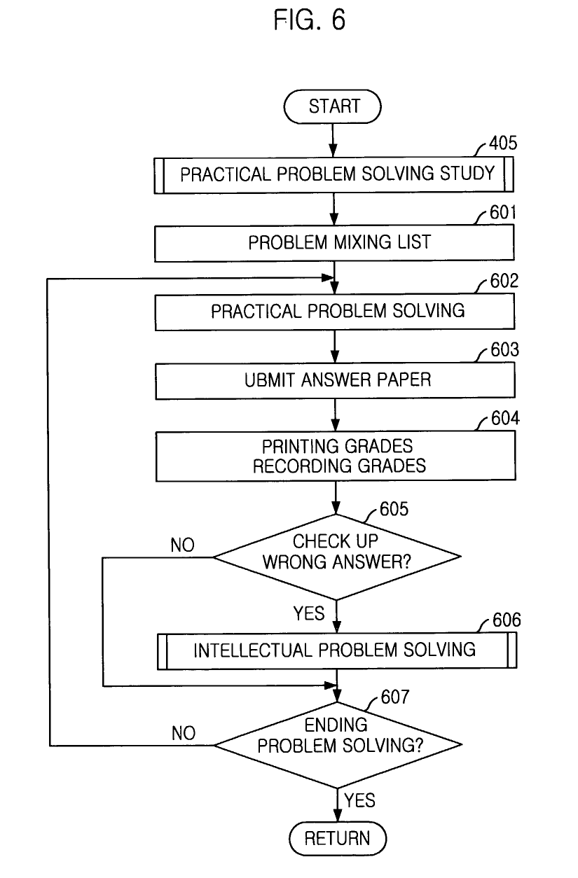

In the meantime, referring to FIG. 6, the procedures of the practical problem solving at step S405 are shown in detail hereinafter.

FIG. 6 is a detailed flow chart showing the learning procedures of a practical problem solving of FIG. 2 in accordance with an embodiment of the present invention. The figure illustrates how the solution of practical problem, which is in a form of real tests, is organically related to the solution of intellectual problems.

Presenting an array of problems without any description, the practical problem solving provides a learner an environment of real tests. At step S402, a learner selects a course, a subject, and a year on the main screen of FIG. 4, and sends the corresponding subject code and information to the database 30 and brings up a combination of problems at step S601.

At step S602, the learner solves the problem and at step S603, he submits the answer sheet. Then at step S604, the correct answers of the given questions are brought up from the database 30 and scores are outputted after comparing the submitted answers with it. At step S604, the outputted score is sent back to the database 30 and stored in individual information of the member.

At step S605, in case the learner wants explanation of the problem to which he got wrong, the question code of the erroneous question is sent to the database 30 and different sets of problems are combined. This way, a new set of intellectual problems that consists of erroneous problems in the practical problem solving are formed at step S606 and at step S607, the learner can have a chance of solving the problems in feedback, proceeding the next problems on ahead. In the midst of solving the problems to which he got wrong, the learner can correct his way of solving problems and strengthen his weak points, his ability of analyzing problems in the same pattern and style improved remarkably.

If a learner wants the whole practical problems to be intellectual, he can solve a set of the same problems in the intellectual style, which is shown in the combination list of FIG. 6 at step S601. What is important is to analyze a problem, determine how to solve it and cultivate the ability of adopting them to the problem.

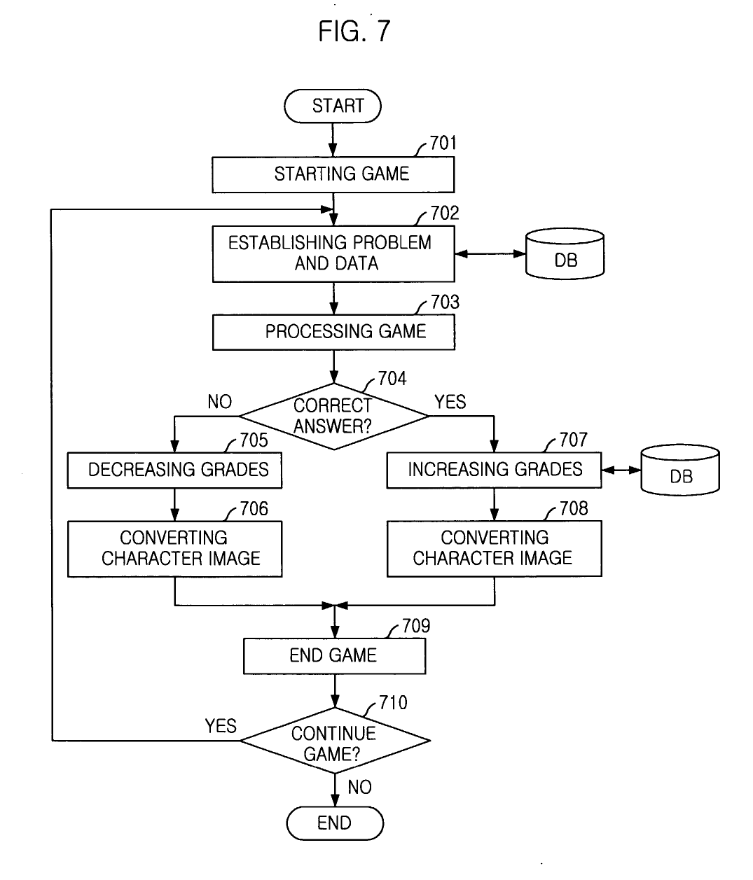

FIG. 7 is a flow chart showing a learning material providing leaning materials in accordance with a second embodiment of the present invention. The figure shows the learning procedures through a game to double the learning effect.

First of all, at step S701, when the type of learning games is selected by the learner, learning materials are brought up from the database 30 and problems and materials are inputted in the game at step S702.

Then at step S703, playing the game, the learner gets to solve the problems and contacts the related learning materials naturally.

In playing the game at the step S703, if the learner gets the right answer, clear the game, or gets a certain level of score at step S704, the increased total score of the learner is recorded in the database at step S705. Also, at step S706, making the learner's character move or showing a message of encouragement or image of congratulation, or by building up a construction structure to complete, the learner's desire for accomplishment is stimulated, which will get the learner more motivated.

Accordingly to the total score, a level or a weapon item or an appearance of the character is given to the learner at steps S706 and S708. According to the selection of the learner, learning through a game is achieved continuously at steps S709 and S710. When the total score reaches a certain level, a special item or a gift may be given for stimulate desire for learning.

Meanwhile, if the learner gets the wrong answer or fail to clear the game in time at step S704, the logic flow goes to step S705 where the total score of the learner is reduced. At step S706, giving the learner's character movement such as reduction, deterioration, or dark countenance, etc, or showing a message of alarm, tense and concentration may be heightened up, which may lead to effective learning.

There is a foreign language learning program made in a form of a game as above. In this program, the native language is arrayed in the order of the corresponding foreign language. Inducing the learning in the word order of English repeatedly, the learner gets naturally familiar to it. Here, inputting, arraying and inserting spellings, words, phrases and sentences in order of words, idioms and phrases, the phrases of the foreign language can be exercised and completed.

Also, when the learner understands or memorizes the words, idioms, phrases, sentences and problems, the learning program in this format of a game can present the words, idioms, phrases, sentences and formulas or other materials necessary for solving the problem for a predetermined time, and then vanish them all. A line or a block of the presented materials can be moved up and down, right to left, left to right, replacing the original material with others then disappearing, or just making the learner to solve problems related to the materials before they are replaced with the others.

Also, when the learner understands or memorizes the words, idioms, phrases, sentences and problems, the learning program in this format of a game can make the spelling of the presented word, idiom and phrase as a piece and its meaning or so as the other piece, thus putting them together like a Tetris game or a jigsaw puzzle.

Also, when the learner understands or memorizes the words, idioms, phrases, sentences and problems, the learning program in this format of a game can raise the score by having a letter or a picture of the game to disappear or blow up like a firecracker if the correct answer or meaning of the question is inputted from the key board or clicked with the mouse, the mouse pointer is dragged onto the correct picture or meaning, or shooting the corresponding letter or picture with an arrow or a gun, e.g., a artillery, a missile, a laser, etc. Also possible is to make the game in the patterns of finding way in a maze, ladder-climbing, finding out hidden pictures or letters, treasure-hunting, twenty questions, detective game, etc., and obtaining the right answer or meaning.

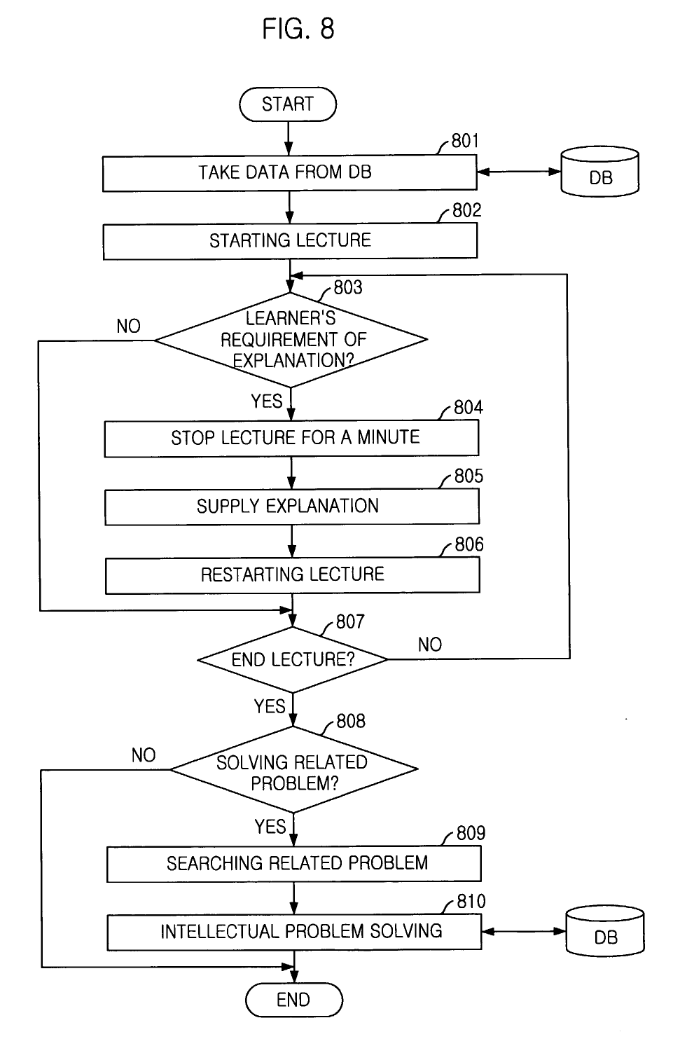

FIG. 8 is a flow chart showing a learning material providing method in accordance with a third embodiment of the present invention. The figure shows leaning procedures through an Internet lecture.

First, when the learner chooses a lecture and a class he wants, the corresponding lecture is brought up from the database 30 at step S801, and provided to him. The contents of the lecture include key points, summary of the lecture, the body, referential texts, problems and so forth.

During lecture, in an important part has an underline, coloring, background color, a circle and a square to make concentrate a learner than watches a fixed screen, to thereby increasing learning ability. Also, when a learner puts or clicks a mouse on an important words, phrases, and sentence, there is displayed a translation, meaning of words/idiom, a reference contents, a grammar, a precedence learning, an evidence, a picture or a moving picture and a related problem, so in case of a learner may not understand and need more detailed explanation, at step S803, make the learner to sufficiently understand the problem at steps s804 to S806 to increase learning capability. For example, in case of an English, when a learner clicks words and sentence, which he or her doesn't know, a meaning of the word, an interpretation, an idiomatic expression, a grammar and related problem are provided.

In case of passing an important word and part of the lecture, it brings about decreasing of the whole lecture, so at step S803, in a required point, a learner selectively shows needed explanations, at steps S804 to S806. As a result, an understanding of whole lecture is increased and learning depth is more improved.

At step S807, after the lecture, an intellectual problem solving related to the corresponding lecture is provided with a learner so that the learner directly is adapted to the problem and analyzes related problems, thereby increasing learning ability, at steps S808 to S810. That is, at step S807, after the lecture, in case of a learner pushes a button linked to an intellectual problem solving, at step S808, the database 30 searches intellectual problems related to the lecture, at step S809, the related problem is provided with the learner, at step S810. At this time, the intellectual problem solving denotes a problem, which is being an essential key in solving a problem or a key word and materials of the problem. Subsequently, when a learner strikes keyboard or clicks mouse to the sorted key words or materials, a linguistic (literal) expression of the key words and material parts are expressed into a numeral formula (Mathematics, Science, Logics). Also, a notion definition, a deduction process of a reference materials and definition, domestic language and foreign language and words, meaning of an idiom, a synonym, an antonym, arrangement of origin of a word, a hint or a reference material related to a key words and materials, cautions and know-how in a problem solving of a key words and materials are provided. Subsequently, discrimination between a correction answer and a similar answer are denoted with numeral value, graph and picture, and the present invention makes clear the standard of the discrimination is related to which on a concept basis, key word and a key materials so that a learner sufficiently understands corresponding problem and increases ability to analysis problem type.

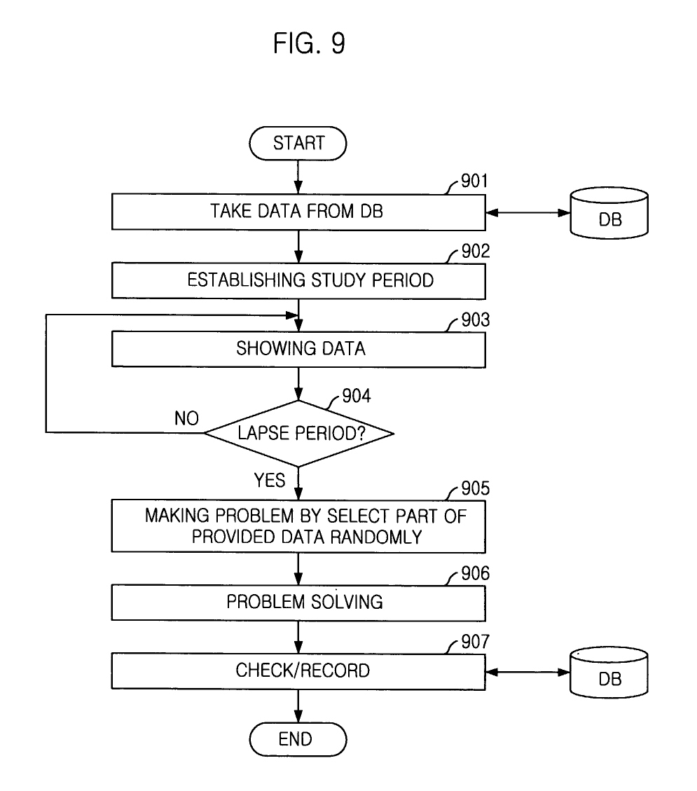

FIG. 9 is a flow chart showing a learning material providing method in accordance with a fourth embodiment of the present invention. Referring to FIG. 9, words, an idiom, sentence, an article formula and an important memorizing contents and other materials for problem solving are provided about predetermined time and disappeared, or after the materials are substituted for other materials and then disappeared, and a learner solves problems related to a former materials.

First, when a learner starts learning, at step S901, materials are taken from the database 30 and show them to the learner. At this time, a period to show the materials to the learner is established at step S902, the materials are shown to the learner in a predetermined period, at step S903, and after passing a predetermined period, the materials are disappeared so that in a fixed period, a learner obtains utmost information to increase learning ability.

After the predetermined period is passed, at step S904, among the materials, which are provided to the learner, the present invention makes problems by randomly selecting the provided materials to solve them by the learner, at the steps S905 and S906.

Just showing learning materials during a fixed period, a learning ability of the learner is not increased, so problems are directly made just after provides learning materials, at step S906, to the learner has a learning goal, thereby making utmost learning effective in a shortest period. For example, an English words and meaning thereof are provided to a learner for a predetermined period, and after passed the predetermined period, asks selected few words to the learner or shows meaning of a words and asks the corresponding words.

After solving the problem, the score is recorded to the database 30 and stored there, at step S907.

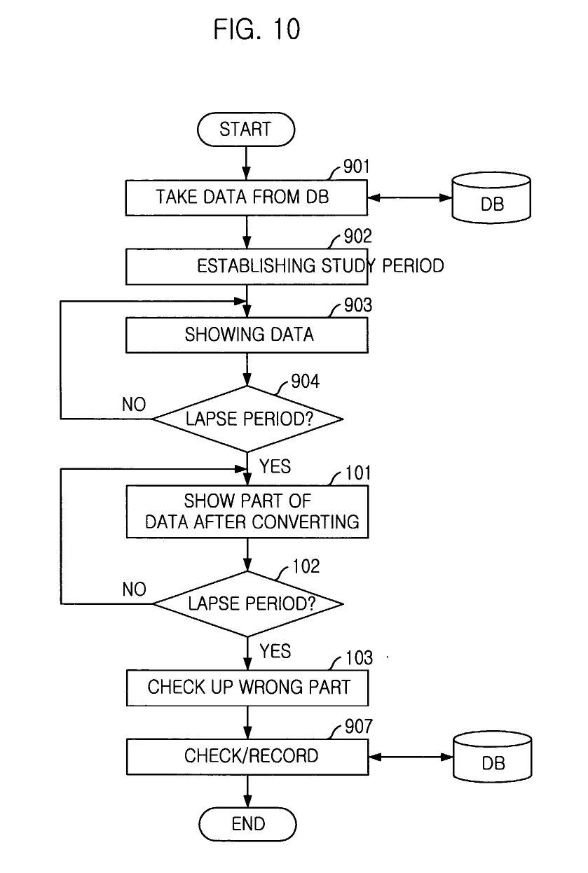

Meanwhile, instead of making problems by randomly selects among the provided data and made a learner solve the problems, as shown in FIG. 9, at step S904, referring to FIG. 10, in a predetermined period, at step 102, the presented materials are partly changed or remained in blank, then shows it to a learner, at step S101, to find changed part or fill in the blank, at step S103.

The present invention may be realized in a program and be stored into a computer readable media (CD-ROM, RAM, ROM, Floppy disk, Hard disk and an optical magnetic disk, etc.).

The present invention increased thinking power of a learner for a problem solving so that learners have an interest to learning as well as give self-confidence to the learner to increase problem solving ability. Also, game learning elements of a computer are added in a boring word, idiom and a sentence memorizing to enjoy the dislike learning more pleasantly.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. An educational material database structure to provide effective learning materials, comprising:
a first material structure storing a plurality of learning problems, which have at least one segment phrase and key word, wherein the segment phrase has at least one word and then provides a meaning associated with the problem to a learner;
a second material structure storing a plurality of detailed materials corresponding to the segment phrase and key word; and
a first table storing correlation information between the first and second material structures.

2. The structure of claim 1, further comprising a second table for denoting the segment phrase or the key word, which have more important contents in solving the problem.

3. The structure of claim 1, the first database structure stores a diagramming material.

4. The structure of claim 1, further comprising a third material structure for storing considerable contents when a learner selects a correct answer among examples presented in an objective selective problem.

5. The structure of claim 4, further comprising a fourth material structure for storing a correct analyzing process in selecting the correct answer according to considerable contents in problem solving.

6. The structure of claim 5, further comprising a fifth material structure for explaining correlation between each examples and contents of the problems.

7. The structure of claim 6, further comprising a sixth material structure for storing contents, which the learner may additionally learn in accordance with the contents of the problems.

8. The structure of claim 7, further comprising a seventh structure for converting the segment phrase or the key word, which are represented in a language, into a numerical formula or a schematize symbol.

9. The structure of claim 1, further comprising a third material structure for storing statistical data obtained by analyzing learning achievement of a learner, on the basis of a problem solving result of a learner.

10. The structure of claim 1, further comprising a third material structure for showing correlation between examples and the provided problem or the segment phrase in the problem.

11. A method for providing learning material to a learner who is connected to a computer system through a network, comprising the steps of:
a) structuring learning material into a database, wherein the learning material may lead to a way of problem solving;
b) providing a corresponded problem to a learner in accordance with a selection or an input of the learner;
c) according to the selection or the input of the learner, showing a corresponding learning material, interpreting a right or a false of the problem solving process by using a problem analyzing material and noticing a result; and
d) presenting a correct problem solving way to check a reason for a false answer to the problem which the learner want to solve.

12. The method of claim 11, wherein the database comprises:
a first material structure for storing a plurality of learning problems, which have at least one segment phrase and a key word, wherein the segment phrase has at least one word, and provides a meaning associated with the problem to a learner;
a second material structure for storing a plurality of detailed materials corresponding to the segment phrase and the key word;
a table for storing correlation information between the first and second material structures;
a second table for denoting the segment phrases or the key words, which have more important contents in solving the problem;
a third material structure for storing considerable contents when a learner selects a correct answer among examples presented in an objective selective problem;
a fourth material structure for storing correct analyzing process in selecting the correct answer according to a considerable contents in problem solving;
a fifth material structure for explaining correlation between each examples and contents of the problems;
a sixth material structure for storing contents, which the learner may additionally learn in accordance with the contents of the problems;
a seventh structure for converting the segment phrase or the key word, which are represented in a language to a numerical expression or a schematize symbol; and
an eighth structure for storing statistical material, which analyzes an achievement rate of the learner based on a result or the problem solving, wherein the problem is a selective type problem in which the learner selects at least one example among the provided examples, and wherein the database further comprises a numeral data structure for showing correlation between the selected example by the learner and the provided problem phrase or segment within the problem.

13. The method of claim 1, wherein the first data structure stores graphical materials.

14. The method of claim 11, wherein the problem solving way at the step d), providing each differentiated hint or materials according to the input method for searching the segment phrase or the key word when hints or referencing materials according to the input method for searching divided on a concept basis or key word.

15. The method of claim 11, wherein in the problem solving way at the step d), each differentiated hint or materials are provided according to the already evaluated learner's level and characteristics, when hints or referencing materials are provided.

16. The method of claim 11, wherein the learning materials are provided to a learner together with an Internet lecture or learning materials.

17. The method of claim 11, wherein the database comprises:
a learning diagnose function for indicating weak part of a learner, statistically, through a problem solving program after accumulating each selection in problem solving as individual data;
a learning correction function for proposing a correction method for a weak part and providing similar problems corresponding to the weak part, repeatedly, so as to overcome the weak part and thoroughly achieve the course;
a learner grading function for grading understanding level of each solving process and learning contents so as to provide problem adapted to the learner's level; and
a learning specific function for providing individual character and problem and education contents according to a required contents and learning course.

18. The method of claim 11, wherein the problem solving direction describes a linguistic (literal) expression of the segmented phrase a numeral formula and a deduction process of a reference materials and definition, providing a precedence learning material and comprises domestic language and foreign language and word, meaning of an idiom, a hint or a reference material related to a key words and materials, cautions and know-how in a problem solving of the key word.

19. The method of claim 11, wherein the database denotes discrimination between a correct answer and a wrong answer into a numeral value, graph and a diagram, and provides standard of the discrimination is related with which on a concept basis, key word and key materials of a problem and materials.

20. The method of claim 11, wherein in the providing the learning material, a plaything is provided together when a learner achieves a learning process for encouraging the learner.

21. A database managing system having a processor for providing effective learning materials, which are recordable in a computer, comprising:
a first material structure for storing a plurality of learning problems, which have at least one segment phrase and a key word, wherein the segment phrase has at least one word, and provides a meaning associated with the problem to a learner;
a second material structure for storing a plurality of detailed materials corresponding to the segment phrase and the key word;
a table for storing correlation information between the first and second material structures;
a second table for denoting the segment phrases or the key words, which have more important contents in solving the problem;
a third material structure for storing considerable contents when a learner selects a correct answer among examples presented in an objective selective problem;
a fourth material structure for storing correct analyzing process in selecting the correct answer according to a considerable contents in problem solving;
a fifth material structure for explaining correlation between each examples and contents of the problems;
a sixth material structure for storing contents, which the learner may additionally learn in accordance with the contents of the problems;
a seventh structure for converting the segment phrase or the key word, which are represented in a language to a numerical expression or a schematize symbol;
an eighth structure for storing statistical material, which analyzes an achievement rate of the learner based on a result or the problem solving; and
a ninth structure for showing correlation between examples and provided problems.

22. A database managing system having a processor for providing effective learning materials, which are recordable in a computer, comprising the functions of:
a) structuring learning material into a database, wherein the learning material may lead to a way of problem solving;
b) providing a corresponded problem to a learner in accordance with a selection or an input of the learner;
c) according to the selection or the input of the learner, showing a corresponding learning material, interpreting a right or a false of the problem solving process by using a problem analyzing material and noticing a result; and
d) presenting a correct problem solving way to check a reason for a false answer to the problem which the learner want to solve.
